(19) United States
(12) Patent Application Publication
(10) Pub. No.: US 2024/0004533 A1
(43) Pub. Date: Jan. 4, 2024

(54) ARRANGING USER INTERFACE ELEMENTS ON DISPLAYS IN ACCORDANCE WITH USER BEHAVIOR ON DEVICES

(71) Applicant: Citrix Systems, Inc., Fort Lauderdale, FL (US)

(72) Inventors: Daowen Wei, Nanjing (CN); Hengbo Wang, Nanjing (CN); Jian Ding, Nanjing (CN); Feng Tao, Nanjing (CN)

(21) Appl. No.: 17/869,293

(22) Filed: Jul. 20, 2022

Related U.S. Application Data
(63) Continuation of application No. PCT/CN2022/102213, filed on Jun. 29, 2022.

(51) Int. Cl. G06F 3/04845; G06F 3/01; G06F 3/0488

(52) U.S. Cl. CPC G06F 3/04845; G06F 3/013; G06F 3/0488; G06V 40/12

(57) ABSTRACT

Described embodiments provide systems and methods for selecting a position for a user interface element. A device may detect a mode of holding the device by a hand of a user using an input of the user. The device may identify an arrangement defining a plurality of positions to present a corresponding plurality of user interface elements on a display based at least on the mode of holding. The device may determine a number of interactions by the hand of the user with a user interface element. The device may, from the plurality of positions, a position to present the user interface element on the display based at least on the number of interactions in accordance with the arrangement.

### CROSS-REFERENCE TO RELATED APPLICATIONS

This application is a continuation of, and claims priority to and the benefit of International Patent Application No. PCT/CN2022/102213, titled “ARRANGING USER INTERFACE ELEMENTS ON DISPLAYS IN ACCORDANCE WITH USER BEHAVIOR ON DEVICES”, and filed on Jun. 29, 2022, the entire contents of which are hereby incorporated herein by references in its entirety for all purposes.

### FIELD OF THE DISCLOSURE

The present application generally relates to graphical user interfaces (GUI). In particular, the present application relates to systems and methods for arranging user interface elements in accordance with user behavior.

### BACKGROUND

A computing device may present one or more user interface (UI) elements on a display. Upon detection of an event with one of the UI elements, the computing device may perform operations as specified by the UI element.

### BRIEF SUMMARY

A user may hold a device (e.g., a smart phone, a tablet, or a handheld computer) in a myriad of methods based on a number of factors, including the type of device, the usage of applications on the device, and other context, among others. The methods of holding the device may include, for example: touching the screen of the device with one thumb, while cradling the device with both hands; using a second hand to hold the device for greater reach and stability; and holding the device in one hand while touching the screen with a finger of the other hand, among others. While using the device, the user may change the method of grasping without being fully cognizant of the change, and may be unable to observe themselves well enough to predict the their own behavior in grasping the device.

Depending on the method of grasping, it may be easier for the finger (e.g., the thumb) of the user's hand to reach certain areas on the screen of the device, than other areas. For instance, the user may grasp the device with the strongest digit of the user's hand, using the thumb to tap or interact with the screen while using the other fingers to hold the device. In this case, the areas of the screen closest to the thumb may be easiest to reach with the thumb, while areas of the screen further away may be difficult to reach. This may be mirrored based on whether the user is left-handed or right-handed. The areas which are easier to reach versus areas which are difficult to reach may also differ based on the method of grasping. In another example, for a user grasping with two hands, the areas of the screen that are difficult to reach may be less than such areas of the screens for a user grasping with their left or right hand.

User interface (UI) elements (e.g., icons for mobile applications) may be arranged on the display in a grid layout. The user may manually arrange these UI elements with the guide of the grid layout. The device may be able to display a limited number (e.g., 16 to 32) of UI elements on the display, due to screen size constraints. On a single page, the UI elements may be arranged from the upper left corner to the bottom-right corner. New UI elements may be appended to last grid, element by element. The UI elements that do not fit on the screen can be placed on another page reachable via a specified user interaction (e.g., a swipe from left to right on the screen) or may be organized into hierarchically organized folders.

From the context of the user holding the device, certain UI elements may be easier to reach than other UI elements on the screen depending on the grid positions. For example, for a user that holds the device in one hand and sweeps with their thumb on the screen, grid positions on the opposite corner of the screen may be difficult to reach. On the other hand, grid positions closer to the thumb diagonally along the screen may be easy to reach. Grid positions in between the two areas may be moderately difficult to reach. Based on the grid positions arranged by difficulty of reach, UI elements in corner positions may be difficult to reach, while UI elements in the middle and closer to the thumb may be easier to reach. As a result, the user may suffer from inconvenience from interacting with UI elements in difficult to reach positions, especially when grasping the mobile device with one hand. This may result in deterioration of quality in human-computer interaction (HCI) between the user and the mobile device.

To address these and other technical challenges, the UI elements displayed on the screen may be arranged based on access frequency and method of grasping. The arrangement of UI elements may be triggered by the user upon request or when the automated switching feature is enabled for the device when a switch in method of grasping is detected. The arrangement of UI elements may be performed on a per-page basis, when the page is to be displayed. To that end, the device may determine the method that the user is using to grasp the device based on data about the user. The method of grasping may generally fall into left-handed, right-handed, or ambidextrous methods. The data about the user may include a heat map of user interactions mapped on the screen, a fingerprint of the user, and location of the eyes of the user relative to the screen, among others.

Using the method of grasping determined for the user, the device may identify a layout arrangement from a set of layout arrangements. Each layout arrangement may correspond to one of the possible methods of grasping for the user, and may define a grid position for each UI element based on frequency of use. The layout arrangement may also divide the display into different areas for grid positions. A first area may classify grid positions as natural grid positions, corresponding to UI elements that are to be placed for easy reach by the thumb of the user given high frequency of use of the UI elements. A second area may classify grid positions as stretch grid positions, corresponding to UI elements that are to be placed for moderately difficult reach by the thumb of the user given moderate frequency of use. A third area may classify grid positions as corner grid positions, corresponding to UI elements that are to be placed for difficult reach by the thumb of the user given low frequency of use.

Upon identifying the layout arrangement, the device may determine a number of interactions for each UI element on the screen from a log of interactions on the device. For each interaction, the log may identify the UI element, the application name, the number of recorded interactions on the UI element, and time stamp for the interaction, among others. The log may have been maintained using a counter for interactions across the UI elements. Using the log, the device may use a function of the number of recorded interactions by the time of receipt of the interaction to determine an estimate for a predicted number of interactions. For example, the function may weigh interactions closer to the present higher than interactions further from the present. The recorded interactions used for predicting may be obtained from a time window relative to the present.

With the determination, the device may sort the UI elements by the predicted number of interactions. In conjunction, the device may maintain lists (or queues) corresponding to the different areas specified by the layout arrangement. For example, the device may instantiate a first queue for UI elements to be assigned to natural grid positions, a second queue for UI elements to be assigned to stretch grid positions, and a third queue for UI elements to be assigned to corner grid positions. Upon sorting, the device may assign the UI elements into the queues in this order. Continuing from the previous example, the device may assign the UI elements in the first queue until full, then UI elements into the second queue until full, and then the remaining UI elements into the third queue until full. Based on the assignment into the queues, the device may select the position for each UI element. For example, UI elements assigned to first queue may be inserted into one of the natural grid positions, UI elements assigned to the second queue may be inserted into one of the stretch grid positions, and UI elements assigned to the third queue may be inserted into one of the corner grid positions.

In this manner, the UI elements may be automatically arranged in accordance with the method of grasping and the number of interactions. UI elements with higher predicted number of interactions may be positioned in grid positions that are of easiest reach to the user. Conversely, UI elements with lower predicted number of interactions may be positioned in gird positions that are of more difficult reach to the user. As a result, the user may be able to easily access UI elements with higher predicted frequency of access closer to their thumb, without being inconvenienced by further placement in a grid position that is difficult to reach. Consequently, the quality of human computer interaction (HCI) between the user and the device may be improved. Furthermore, the arrangement of the UI elements may prevent or reduce waste in consumption of computing resources incurred from the user unintentionally interacting with UI elements that are within easy reach but are not often used.

Aspects of the present disclosure are directed to systems, methods, and non-transitory readable media for selecting a position for a user interface element. A device may detect a mode of holding the device by a hand of a user using an input of the user. The device may identify an arrangement defining a plurality of positions to present a corresponding plurality of user interface elements on a display based at least on the mode of holding. The device may determine a number of interactions by the hand of the user with a user interface element. The device may, from the plurality of positions, a position to present the user interface element on the display based at least on the number of interactions in accordance with the arrangement.

In some embodiments, the device may detect the mode of holding based at least on a position of an eye of the user relative to the display determined using the input including an image of the user. In some embodiments, the device may detect the mode of holding based at least on the input identifying a plurality of coordinates for a plurality of interactions on the display. In some embodiments, the device may detect the mode of holding based at least on the input including a fingerprint of the user acquired via the device.

In some embodiments, the device may select the arrangement from a plurality of arrangements for a corresponding plurality of modes of holding. Each of the plurality of arrangements may define a sequence for the plurality of positions. In some embodiments, the device may determine an estimate for the number of interactions as a function of a plurality of interactions with the user interface element over a time window.

In some embodiments, the device may sort the plurality of user interface elements by the number of interactions by the hand of the user with each of the plurality of user interface elements. In some embodiments, the device may identify from a plurality of areas defined by the arrangement, an area of the display for the user interface element in accordance with sorting the plurality of the user interface elements. In some embodiments, the device may select the position from a subset of positions defined for the area by the arrangement.

In some embodiments, the device may detect a switch from the mode of holding the device to a second mode of holding the device using a second input of the user. In some embodiments, the device may determine to arrange the plurality of user interface elements on the display responsive to detecting the switch to the second mode of holding.

In some embodiments, the device may receive, from the user, a request to arrange the plurality of user interface elements on the display. In some embodiments, the device may determine to arrange the plurality of user interface elements on the display responsive to receiving the request. In some embodiments, the device maintain a counter to track the number of interactions by the user with the user interface element on the device.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device;

FIG. 1B is a block diagram depicting a computing environment comprising client device in communication with cloud service providers;

FIG. 2 is a block diagram of a system for arranging user interface elements in accordance with user holding behavior in accordance with an illustrative embodiment;

FIG. 3 is a block diagram of a process for detecting mode of holding in the system for arranging user interface elements in accordance with an illustrative embodiment;

FIG. 4 is a block diagram of examples of modes of holding in the system for arranging user interface elements in accordance with an illustrative embodiment;

FIGS. 5A and 5B each are block diagrams of a coordinate space for detecting modes of holding using eye positioning in the system for arranging user interface elements in accordance with an illustrative embodiment;

FIG. 6 is a block diagram of an interaction heat map to be used detecting modes of holding in the system for arranging user interface elements in accordance with an illustrative embodiment;

FIG. 7 is a block diagram of a process for selecting arrangements in the system for arranging user interface elements in accordance with an illustrative embodiment;

FIG. 8 is a block diagram of a display of a device with definitions of areas in the system for arranging user interface elements in accordance with an illustrative embodiment;

FIGS. 9A and 9B each are block diagrams of arrangements for user interface elements in the system for arranging user interface elements in accordance with an illustrative embodiment;

FIG. 10 is a block diagram of a process for counting interactions in the system for arranging user interface elements in accordance with an illustrative embodiment;

FIG. 11 is a block diagram of a process for sorting the user interface elements by count in the system for arranging user interface elements in accordance with an illustrative embodiment;

FIG. 12 is a block diagram of a process for assigning positions for the user interface elements in the system for arranging user interface elements in accordance with an illustrative embodiment;

FIG. 13 is a block diagram of a re-arrangement of user interface elements in the system for arranging user interface elements in accordance with an illustrative embodiment;

FIG. 14 is a flow diagram of a method of counting user interactions on user interface elements in accordance with an illustrative embodiment;

FIG. 15 is a flow diagram of a method of sorting user interface elements by count and assigning user interface elements into queues in accordance with an illustrative embodiment;

FIG. 16 is a flow diagram of a method of assigning user interface elements into grid positions in accordance with an illustrative embodiment; and

FIG. 17 is a flow diagram of a method of arranging user interface elements in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein; and

Section B describes systems and methods for arranging user interface elements in accordance with user holding behavior on displays.

### A. Computing Environment

Prior to discussing the specifics of embodiments of the systems and methods of an appliance and/or client, it may be helpful to discuss the computing environments in which such embodiments may be deployed.

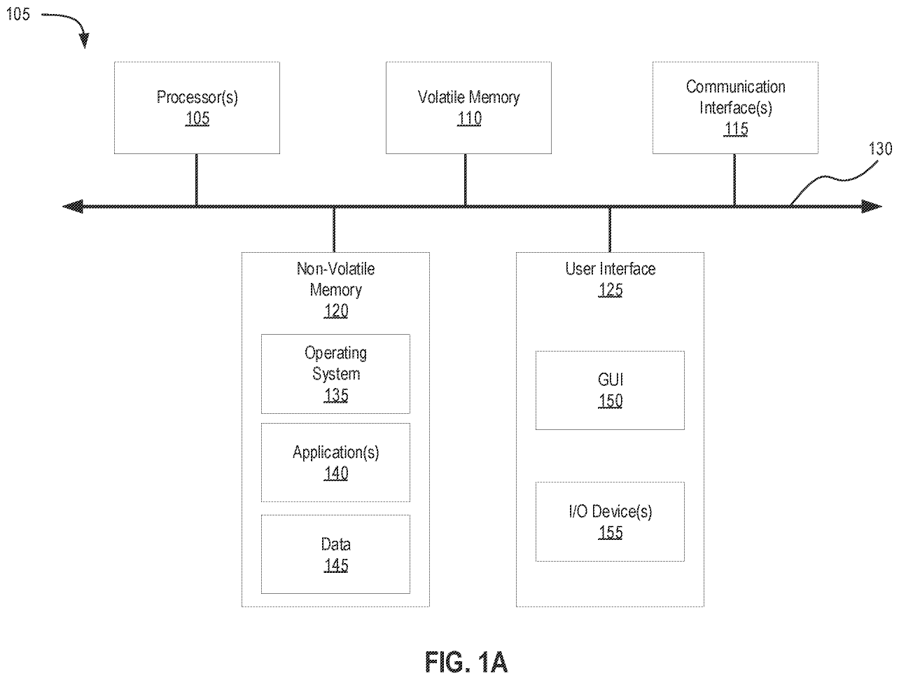

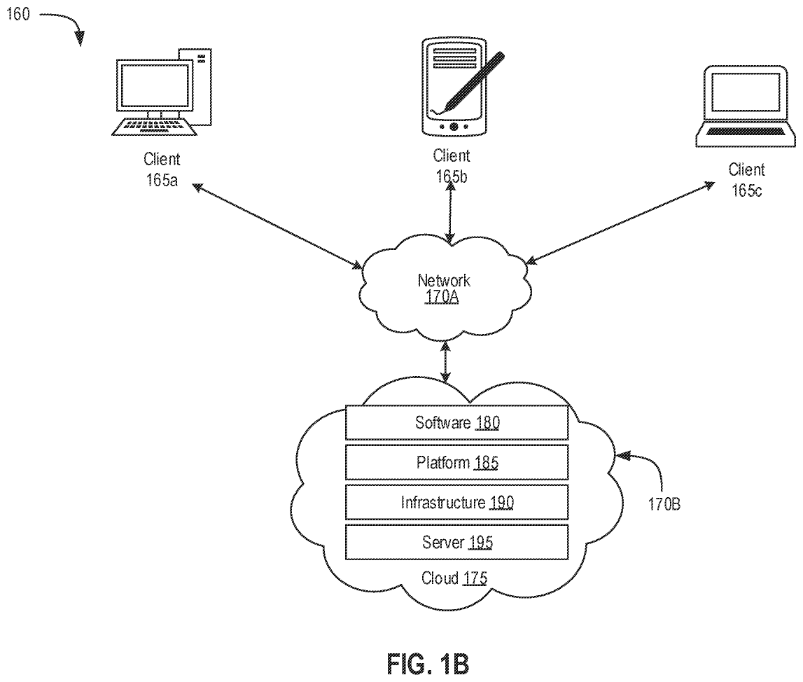

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 135, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170. Clients 165 may include, e.g., thick clients, thin clients, and zero clients. The cloud 175 may include back end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

B. Systems and Methods for Arranging User Interface Elements on Displays in Accordance with User Holding Behavior

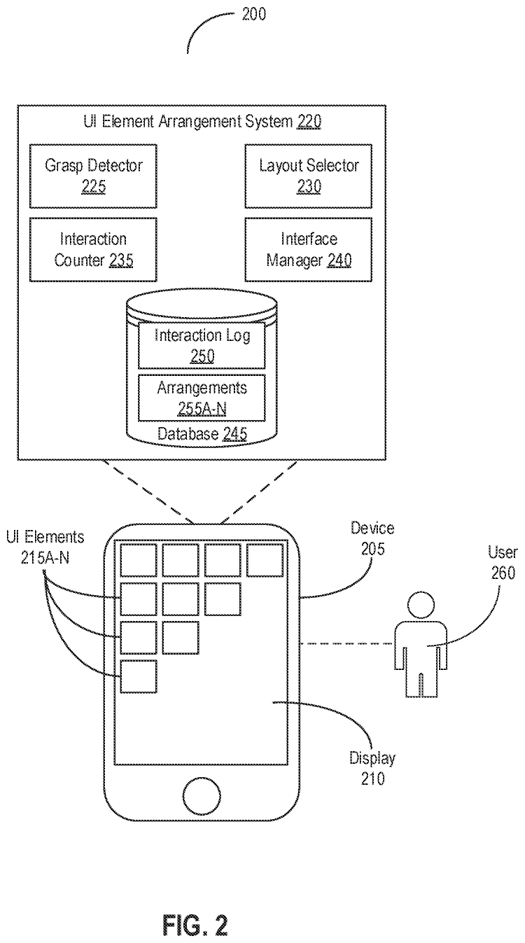

Referring now FIG. 2, among others, depicted is a block diagram of a system 200 for arranging user interface elements in accordance with user holding behavior. The system 200 may include at least one device 205. The device 205 may include at least one display 210. The display 210 may be an input/output (I/O) component to detect or receive user interactions (e.g., tap or screen touch) thereon and to render, display, or otherwise present one or more user interface (UI) elements 215A-N (hereinafter generally referred to as UI elements 215). The device 205 may also include at least one UI element arrangement system 220. The UI element arrangement system 205 may include at least one grasp detector 225, at least one layout selector 230, at least one interaction monitor 235, at least one interface manager 240, and at least one database 245. The database 245 may store, maintain, or otherwise include at least one interaction log 250 and a set of arrangements 255A-N (hereinafter generally referred to as arrangements 255), among others. The device 205 may be a smart phone, a tablet, a wearable device, or a handheld computer operated by a user 260, and the user 260 may interact with one or more of the UI elements 215 via the display 210.

The UI element arrangement system 220 may be implemented at least partly on the device 205. In some embodiments, the UI element arrangement system 220 may be a part of the device 205 (e.g., the client 165). For example, the UI element arrangement system 220 may be part of an operating system (OS) on the device to manage the placement of UI elements 215 on the display 210 (e.g., on a page layout in a home screen). The UI element arrangement system 220 may be part of an application executing on the device 205 to management the placement of UI elements 215 on a graphical user interface (GUI) of the application presented via the display 210. In some embodiments, the UI element arrangement system 220 may be part of a remote server (e.g., the server 195). For instance, the UI element arrangement system 220 may communicate with the device 205 (e.g., via the network 170) to manage the placement of UI elements 215 on the display 210 for the OS or the GUI on an application running on the device 205. The functionalities of the UI element arrangement system 220 may be partitioned across the device 205 and the remote server.

Each of the above-mentioned elements or entities is implemented in hardware, or a combination of hardware and software, in one or more embodiments. Each component of the system 200 may be implemented using hardware or a combination of hardware or software detailed above in connection with FIG. 1. For instance, each of these elements or entities can include any application, program, library, script, task, service, process or any type and form of executable instructions executing on hardware of the system 200. The hardware includes circuitry such as one or more processors in one or more embodiments.

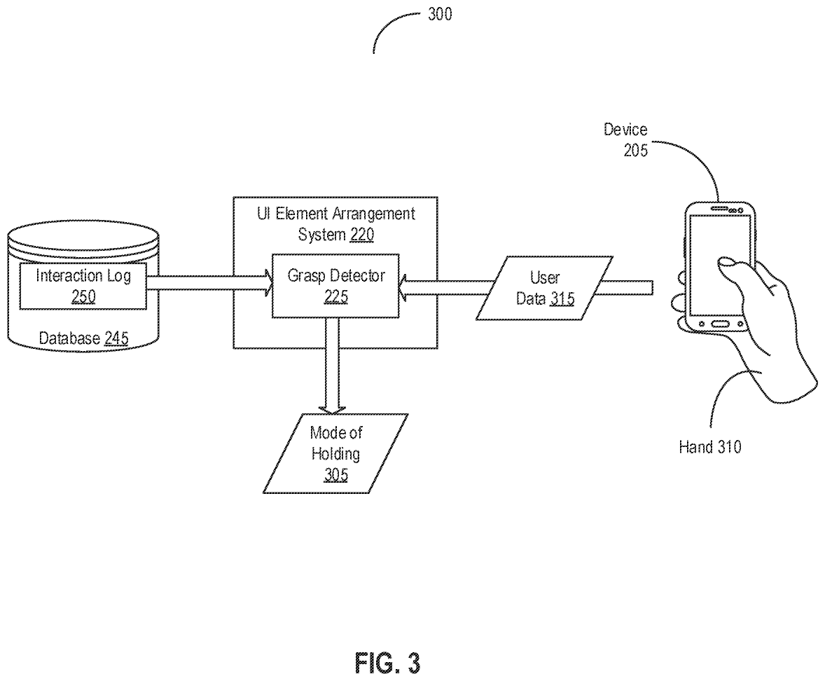

Referring now to FIG. 3, among others, depicted is a block diagram of a process 300 for detecting mode of holding in the system for arranging user interface elements. The process 300 may include or correspond to operations in the system 200 to determine modes of holding (e.g., grasping) the device. Under the process 300, the grasp detector 225 executing on the UI element arrangement system 220 may identify, determine, or otherwise detect a mode of holding 305 by at least one hand 310 of the user 260. The mode of holding 305 may correspond to a method with which the user 260 is securing, grasping, or otherwise holding the device 205 with one (e.g., left or right) or both hands 310. For example, the mode of holding 305 may include holding the device with the left hand, with the right hand, or with both hands. The hand 310 may correspond to the left hand or the right hand (or both) that the user 260 uses to touch, tap, or otherwise interact the display 210 of the device 205.

The detection of the mode of holding 305 by the grasp detector 225 may be based on one or more inputs associated with the user 260, such as the interaction log 250 and user data 315, among others. The interaction log 250 may identify user interactions by the user 260 with the device 205. The user data 315 may include, for example, an image of a face of the user 260 and a fingerprint of a finger of the user 260, among others. Using the inputs of the user 260, the grasp detector 225 may identify or select a mode of holding 305 from a set of candidate modes of holding 305. Each mode of holding 305 may correspond, correlated with, or otherwise be associated with a set of inputs of the user 260. In some embodiments, the grasp detector 225 may store and maintain an association between the user 260 (e.g., using an user identifier) and the detected mode of holding 305. The association may be in accordance with one or more data structures, such as a linked list, queue, tree, heap, stack, array, or matrix, among others.

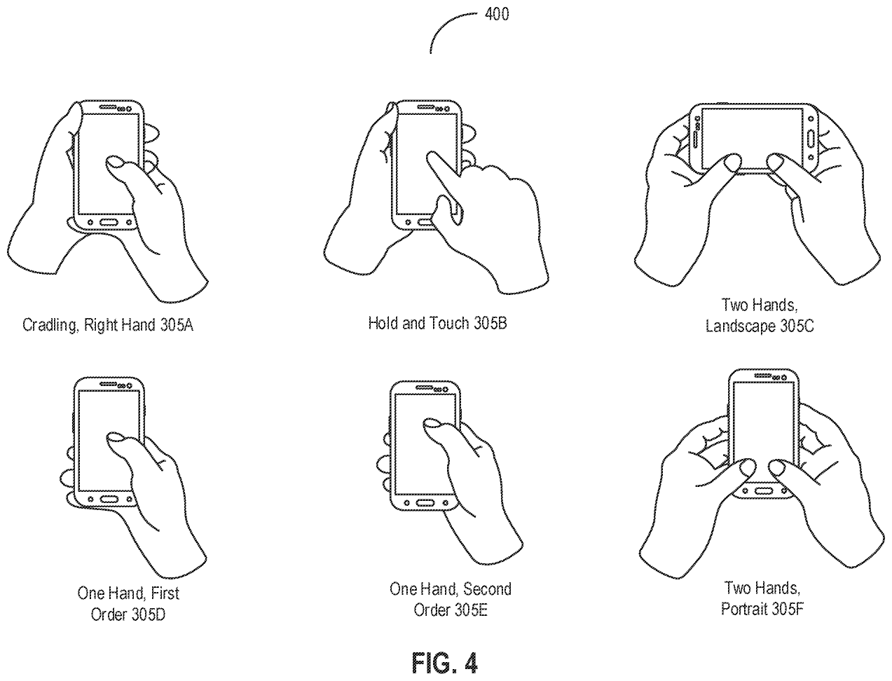

Referring now to FIG. 4, among others, depicted is a block diagram of examples 400 of modes of holding 305A-N in the system 200 for arranging user interface elements. As depicted, the mode of holding 305A may correspond to the user 260 cradling the device 205 with both hands and using the right hand 310 to interact with the display 210. The mode of holding 305B may correspond to the user 260 holding the device 205 with the left hand and using the right hand 310 to interact with the display 210. The mode of holding 305C may correspond to the user 260 holding the device 205 in a landscape orientation, using both the left and right hands 310 to interact with the display 210 of the device 205. The mode of holding 305D may correspond to the user 260 holding the device 205 with the right hand 310 in accordance with a first order. The mode of holding 305E may correspond to the user 260 holding the device 205 with the right hand 310 in accordance with a second order. The mode of holding 305F may correspond to the user 260 holding the device 205 with both the left and right hands 310 and interacting with the display 210 using both hands 310. There may be additional modes of holding 305 detectable by the grasp detector 225 besides those depicted herein. For example, the modes of holding 305 with the right hand 310 may be mirrored to have the left hand 310 holding or interacting with the screen 210 of the device 205.

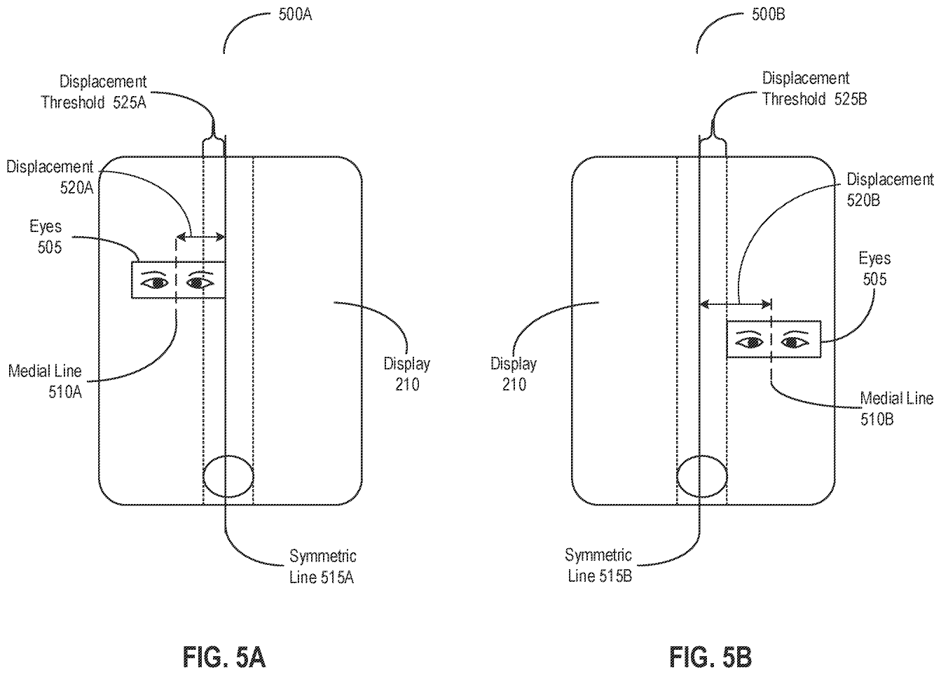

Referring now to FIGS. 5A and 5B, depicted are block diagrams of a coordinate space 500A and 500B for the process 300 of detecting modes of holding using eye positioning in the system 300 for arranging user interface elements. The coordinate space 500A may correspond to the scenario of when the eyes of the user 260 are generally in the left half of the display 210. The coordinate space 500B may correspond to the scenario of when the eyes of the user 260 are generally in the right half of the display 210. Each coordinate space 500 may define a set of pixel coordinates over the display 210 of the device 205. The coordinate space 500 may be used when determining the mode of holding 305.

The grasp detector 225 may detect the mode of holding 305 based on a position of the eyes 505 of the user 260 relative to the display 210. In determining, the grasp detector 225 may retrieve, receive, or otherwise identify the user data 315 to be used to identify or determine the position of the eyes 505. The user data 315 may include one or more images of the user 260 via a sensor (e.g., a camera) of the device 205. The face of the user 260 may be generally situated, arranged, or otherwise positioned over the display 210 of the device 205. The image acquired via the sensor may include the face of the user 260 including the eyes 505. The grasp detector 225 may retrieve, identify, or otherwise receive the user data 315 including the one or more images via the sensor of the device 205.

Using the images in the user data 315, the grasp detector 225 may calculate, identify, or otherwise determine the position of the eyes 505 of the user 260 relative to the display 210. To determine, the grasp detector 225 may determine or identify a medial line 510A or 510B (hereinafter generally referred to as medial line 510) for the eyes 505 from the images of the user data 315. The medial line 510 may correspond to a line generally between the eyes 505 of the user 260 along at least one axis of the display 210. In the depicted example, the medial line 510 may correspond to a vertical line partitioning the left eye and the right eye of the user 260 along the vertical axis of the display 210. The medial line 510 may be defined in terms of the pixel coordinates of the coordinate space 500, such as the starting and ending pixel coordinates.

In some embodiments, the grasp detector 225 may identify the medial line 510 for the eyes 505, in accordance with a computer vision algorithm. The algorithm may include, for example, principal component analysis (PCA) using eigenfaces, linear discriminant analysis (LDA), elastic matching, tensor representations, and deep learning, among others. For example, the grasp detector 225 may generate a set of eigenvectors using the image in the user data 315. By applying the set of eigenvectors to PCA, the grasp detector 225 may identify pixel coordinates for the eyes 505 in the image. Based on the pixel coordinates for the eyes 505, the grasp detector 225 may determine the medial line 510 to divide the eyes 505 in the image. In some embodiments, the grasp detector 225 may calculate, identify, or otherwise determine a medial point between the pixel coordinates for the eyes 505. For instance, the grasp detector 225 may determine the medial point as an average of the pixel coordinates of the eyes 505. Using the medial point, the grasp detector 225 may determine the medial line 510 by extending along the axis of the display 210.

With the identification, the grasp detector 225 may compare the medial line 510 with at least one symmetric line 515A or 515B (hereinafter generally referred to as a symmetric line 515). The symmetric line 515 may correspond to a line along at least one axis of the display 210 to divide or partition the display 210. In the depicted example, the symmetric line 515 may be the line along the vertical axis of the display 210 to divide the display 210 into a substantially equal (e.g., within 90%) left and right halves. In comparing, the grasp detector 225 may calculate, generate, or otherwise determine at least one displacement 520A or 520B (hereinafter generally referred to as displacement 520). The displacement 520 may indicate, measure, or otherwise correspond to a difference between the medial line 510 and the symmetric line 515 along at least one axis of the display 210. For instance as depicted, the displacement 520 may correspond to a horizontal difference between the media line 510 and the symmetric line 520 along the horizontal axis on the display 210.

Upon determination, the grasp detector 225 may compare the displacement 520 with at least one displacement threshold 525A or 525B (hereinafter generally referred to as a displacement threshold 525). The displacement threshold 525 may delineate, identify, or otherwise define a value for the displacement 520 relative to the symmetric line 515 at which one of the modes of holding 350 is determined. In the depicted examples, the displacement threshold 525A may correspond to a value for the displacement 520A above which the mode of holding 350 is determined to be holding with the right hand 310, as the eyes 505 of the user 260 are determined to be on the left side of the display 210. Conversely, the displacement threshold 525A may correspond to a value for the displacement 520B above which the mode of holding 350 is determined to be holding with the left hand 310, as the eyes 505 of the user 260 are determined to be on the right side of the display 210.

Based on the comparison between the displacement 520 and the displacement threshold 525, the grasp detector 225 may determine the mode of holding 350. When the displacement 520A satisfies (e.g., greater than or equal to) the displacement threshold 525A (e.g., as depicted in FIG. 5A), the grasp detector 225 may determine that the position of eyes 505 is on the left side of the display 210. In addition, the grasp detector 225 may determine the mode of holding 530 as holding with the right hand 310. When the displacement 520A does not satisfy (e.g., less than) the displacement threshold 525A, the grasp detector 225 may determine that the position of the eyes 505 is on the right side of the display 210. The grasp detector 225 may also determine the mode of holding 530 as holding with the left hand 310. In some embodiments, the grasp detector 225 may determine to use another user data 315 for determining the mode of holding 350, if the displacement 520A does not satisfy the displacement threshold 525A.

In addition, when the displacement 520B satisfies (e.g., greater than or equal to) the displacement threshold 525B (e.g., as depicted in FIG. 5B), the grasp detector 225 may determine that the position of eyes 505 is on the left side of the display 210. In addition, the grasp detector 225 may determine the mode of holding 530 as holding with the left hand 310. When the displacement 520B does not satisfy (e.g., less than) the displacement threshold 525B, the grasp detector 225 may determine that the position of the eyes 505 is on the right side of the display 210. The grasp detector 225 may also determine the mode of holding 530 as holding with the right hand 310. In some embodiments, the grasp detector 225 may determine to use another user data 315 for determining the mode of holding 350, if the displacement 520B does not satisfy the displacement threshold 525B.

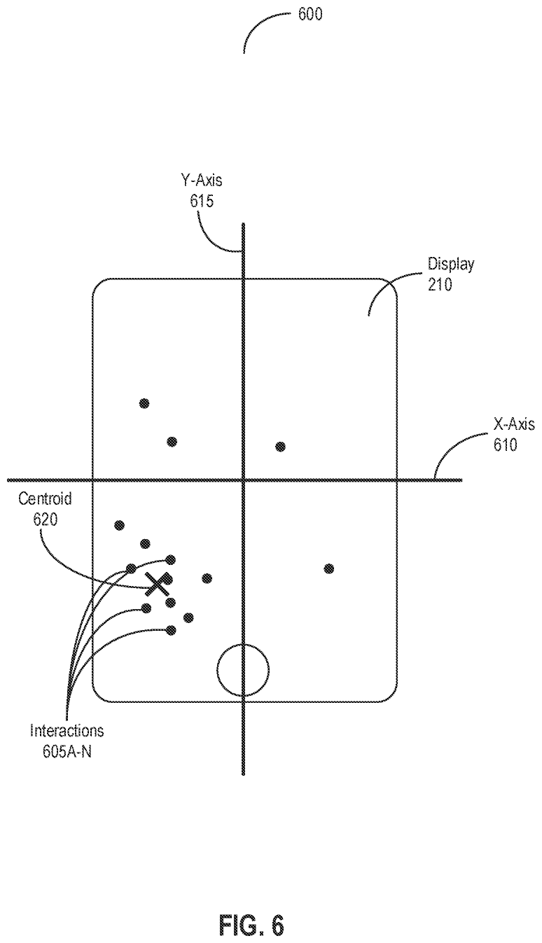

Referring now to FIG. 6, among others, depicted is a block diagram of an interaction heat map 600 to be used detecting modes of holding in the system 300 for arranging user interface elements. The interaction heat map 600 may include or identify a set of interactions 605A-N (hereinafter generally referred to as interactions 605). The interaction heat map 600 may identify or define an x-axis 610 and a y-axis 615. The x-axis 610 and the y-axis 615 may define a coordinate space for pixels of the display 210, upon which the set of interactions 605 may be mapped. The x-axis 610 may be defined relative to one side (e.g., a width) of the device 205. The y-axis 615 may be defined relative to another side (e.g., a length) of the device 205. In the depicted example, the x-axis 610 may be defined to divide the display 210 into a top half and a bottom half and the y-axis 615 may be defined to divide the display 210 into a left half and a right half. Each interaction 605 may be defined by a set of pixel coordinates on the x-axis 610 and y-axis 615 on the display 210. Each interaction 605 may reference or correspond to a user interaction (e.g., a screen touch or tap) detected on the display 210. Each interaction 605 may be recorded as part of the interaction log 250 stored and maintained on the database 245.

The grasp detector 225 may detect the mode of holding 305 based on the set of pixel coordinates for the corresponding set of interactions 605 on the display 210. In some embodiments, the grasp detector 225 may access the database 245 to fetch, retrieve, or identify the interaction log 250. The interaction log 250 may identify or include the set of interactions 605 on the display 210 identified by the set of pixel coordinates. In some embodiments, the interaction log 250 may include the set of interactions 605 within a defined time window from the present. Using the interaction log 250, the grasp detector 225 may construct, determine, or generate the interaction heat map 600. The interaction heat map 600 may be used by the grasp detector 225 to define the set of interactions 605 against the x-axis 610 and the y-axis 615 on the display 210. According to the interaction heat map 600, the grasp detector 225 may generate, calculate, or otherwise determine at least one centroid 620 of the set of coordinates for the corresponding set of interactions 605 on the display 210. The centroid 620 may identify or correspond to a mean value of pixel coordinates among the set of pixels for the corresponding set of interactions 605 in the interaction heat map 600.

Based on the coordinates of the centroid 620 relative to the x-axis 610 or the y-axis 615 of the interaction heat map 600, the grasp detector 225 may determine the mode of holding 305 of the hand 310 of the user 260. In some embodiments, the grasp detector 225 may apply or use a clustering algorithm on the set of interactions 605 to determine a set of centroids 620. When the centroid 620 is in top-left quadrant in the interaction heat map 600 as defined by the x-axis 610 and the y-axis 615, the grasp detector 225 may determine the mode of holding 305 as, for example, holding the device 210 with the left hand while interacting with the right hand 310. When the centroid 620 is in top-right quadrant, the grasp detector 225 may determine the mode of holding 305 as, for example, holding the device 210 with the right hand while interacting the left hand 310. When the centroid 620 is in the bottom-left quadrant (e.g., as depicted), the grasp detector 225 may determine the mode of holding 305 as, for example, holding and interacting the device 210 with the left hand 310. When the centroid 620 is in the bottom-right quadrant, the grasp detector 225 may determine the mode of holding 305 as, for example, holding and interacting the device 210 with the right hand 310. When the centroids 620 are in the bottom-left quadrant and bottom-right quadrant, the grasp detector 225 may determine the mode of holding 305 as, for example, holding and interacting the device 210 with both the left and right hand 310.

In some embodiments, the grasp detector 225 may detect or determine the mode of holding 305 based on at least one fingerprint of the user 260. In determining, the grasp detector 225 may retrieve, receive, or otherwise identify the data user data 315 to acquire the fingerprint of the user 260. The user data 315 may include sensor data of the fingerprint of the user 260 acquired via a sensor of the device 205, such as an optical scanner, a capacitive scanner, or a thermal scanner, among others. For example, the fingerprint may be acquired via a sensor placed in the display 210 of the device 205. The fingerprint may be from a finger of the left hand or the right hand of the user 260. In some embodiments, the sensor data in the user data 315 identifying multiple fingerprints of the user 260. For example, the grasp detector 225 may acquire multiple fingerprints detected via the sensor on the display 210 of the device 205.

With the acquisition, the grasp detector 225 may identify or determine whether the fingerprint is from the left hand or the right hand of the user 260 in detecting the mode of holding 305. To determine, the grasp detector 225 may identify or determine at least one characteristic of the sensor data of the fingerprint. The characteristic may include, for example, a loop, whorl, or arch, among others. Certain sets of characteristics may be correlated with fingers of the left hand, while other sets of characteristics may be correlated with fingers of the right hand. When the characteristics of the fingerprint correspond to a finger of the left hand, the grasp detector 225 may identify that the fingerprint is from the left hand. The grasp detector 225 may also determine that the mode of holding 305 is with the left hand. When the characteristics of the fingerprint correspond to a finger of the right hand, the grasp detector 225 may identify that the fingerprint is from the right hand. The grasp detector 225 may also determine that the mode of holding 305 is with the right hand. When the characteristics of multiple fingerprints correspond to both the finger of the left hand and the finger of the right hand, the grasp detector 225 may identify that the fingerprints are from both hands. In addition, the grasp detector 225 may determine that the mode of holding 305 is with both the left and right hands.

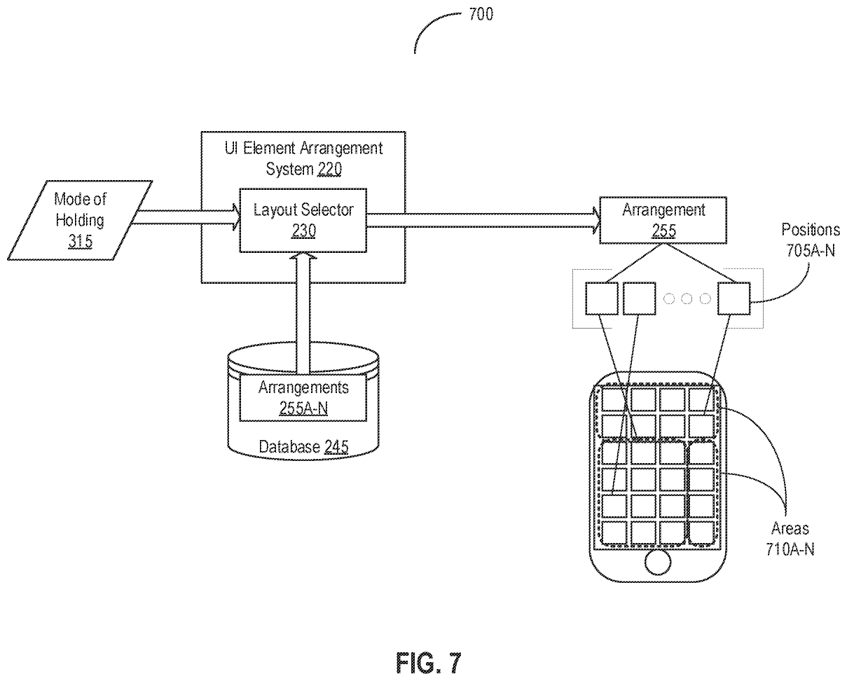

Referring now to FIG. 7, depicted is a block diagram of a process 700 for selecting arrangements in the system 200 for arranging user interface elements. The process 700 may include or correspond to operations in the system 200 for selecting layout arrangements for display on the device. Under the process 700, the layout selector 230 executing on the UI element arrangement system 220 may find, select, or otherwise identify an arrangement 255 based on the detected mode of holding 305 for the user 260. The arrangement 255 may be identified from the set of arrangements 255 maintained on the database 245. For example, the arrangement 255 may be stored in the form of one or more data structures (e.g., a linked list, tree, queue, stack, hash table, or heap) on the database 245. Each arrangement 255 may correspond to or may be associated with a respective mode of holding 305.

Each arrangement 255 may specify, identify, or otherwise define a set of positions 705A-N (hereinafter generally referred to as positions 705) to present the corresponding UI elements 215. The arrangement 255 may specify, identify, or otherwise define a sequence for insertion, placement, or otherwise assignment of the UI elements 215 into the set of positions 705 in accordance a number (e.g., predicted, expected, or recorded) of interactions with the UI elements 215. For example, the sequence may specify that UI elements 215 with higher number of interactions be placed into one of the positions 705 earlier in order, prior to UI elements 215 with lower number of interactions. For example, the UI element 215 with the highest number of interactions may be assigned to the first position 705A, whereas the UI element 215 with the lowest number of interactions may be assigned to the last position 705N. Each position 705 may correspond to a defined set of pixel coordinates (e.g., x, y coordinates) or a defined grid location (e.g., using array or matrix coordinates), among others on the display 210. In some embodiments, each position 705 may correspond to the defined set of pixel coordinates or the defined grid location within a graphical user interface of an application on the device 205 presented on the display 210. Each position 705 may be a location on the display 210 (or the graphical user interface of the application) on which a corresponding UI element 215 is to be presented. The set of position 705 may equal or be less than in number than the number of UI elements 215 to be presented on the display 210 (or the application running on the device 205).

The arrangement 255 may also specify, identify, or otherwise define a set of areas 710A-N (hereinafter generally referred to as areas 710) (sometimes referred herein as regions). Each area 710 may identify or include a subset of positions 705 in the arrangement 255. Each area 710 may correspond or be associated with a priority (or classification) for insertion of a subset of UI elements 215 into a corresponding subset of positions 705 based on the number of interactions on each UI element 215. The priority for the area 710 may be associated with a level of difficulty of interaction by the hand 310 of the user 260 (e.g., with the thumb of the hand 310) for the detected mode holding 305 with the display 215 of the device 205. The arrangement 255 may identify, for example, include: a first area 710A for U UI elements 215 with the highest number of interactions to be inserted into the associated subset of U positions 705 associated with the lowest or first level of difficulty, a second area 710B for V UI elements 215 with the middle number of interactions into the associated V subset of positions 705 associated with a second level of difficulty, and a third area 710C for W UI elements 215 for the lowest number of interactions into the associated subset of W positions 705 associated with a third or highest level of difficulty. In general, the areas 710 associated with the highest number of interactions may be positioned in a location on the display 210 that is easier to be reached by the hand 310 for the given mode of holding 305. Conversely, the areas 710 associated with the lowest number of interactions may be positioned in a location of the display 210 that is more difficult to be reached by the hand 310 for the given mode of holding 305.

From the correspondence between the arrangements 255 and the respective modes of holding 305, the layout selector 230 may select the arrangement 255 for the detected mode of holding 305. The selected mode 255 may define the set of positions 705 such that the UI elements 215 with the highest number of interactions are located on the display 210 that is easier to be reached by the hand 310 for the given mode of holding 305. In some embodiments, the layout selector 230 may access the database 245 to identify the set of arrangements 255 maintained thereon. From the set of arrangements 225, the layout selector 230 may select the arrangement 255 associated with the detected mode of holding 305 for the user 260. In some embodiments, the layout selector 230 may store and maintain an association between the user 260 and the selected arrangement 255 on the database 245. The association may be in accordance with one or more data structures, such as a linked list, tree, queue, stack, hash table, or heap, among others.

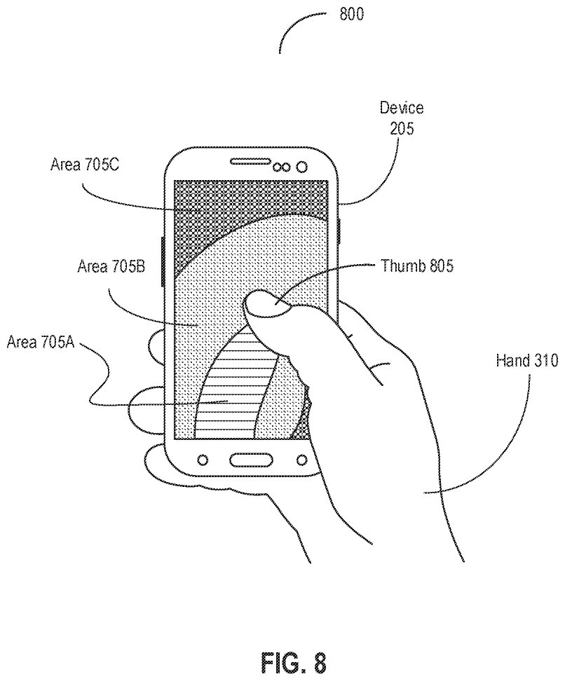

Referring now to FIG. 8, among others, depicted is a block diagram of an example 800 of the display 210 of the device 205 with definitions of areas in the system for arranging user interface elements. As depicted, the user 260 may be holding the device 205 with the right hand 310, and may use a thumb 810 to sweep across the display 210 of the device 205 to interact with the UI elements 205. The detected mode of holding 305 for the hand 310 in the depicted example may be thumb-sweep right hand. To account for this mode of holding 305, the arrangement 255 may define: the first area 705A to be a portion of the display 210 within easiest reach of the thumb 805; the second area 705B to be a portion of the display 210 with moderately difficult in reach for the thumb 805; and the third area 705C to be a portion of the display 210 that is most difficult to reach with the thumb 805 of the hand 310.

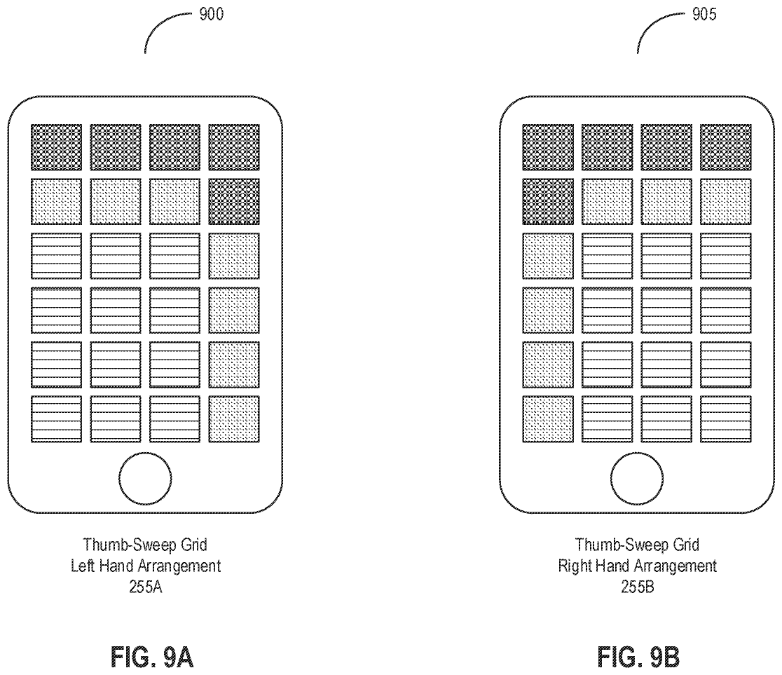

Referring now to FIGS. 9A and 9B, among others, depicted are block diagrams of examples of arrangements 255A and 255B respectively for user interface elements in the system 200 for arranging user interface elements. The arrangement 255A may define the set of positions 705 for the UI elements 215 and may be selected when the mode of holding 305 is for a thumb-sweep, right-hand mode of holding. The arrangement 255A may define a first area 710A (also referred herein as a “natural area”) generally along the bottom left for the positions 705 of UI elements 215. The UI elements 215 to be placed in the first area 710A may have a higher number of interactions and may be easier for the hand 310 to interact with. The arrangement 255A may define a second area 710B (also referred herein as a “stretch area”) generally along the right side or the upper middle line of positions 705 for UI elements 215. The UI elements 215 to be placed in the second area 710B may have a lower number of interactions and may be moderately difficult for the hand 310 to interact with. The arrangement 255A may define a third area 710C (also referred herein as a “corner area”) generally along the top-right corner for the positions 705 of UI elements 215. The UI elements 215 to be placed in the third area 710C may have the lowest number of interactions and may be difficult for the hand 310 to interact with.

In addition, the arrangement 255B may define the set of positions 705 for the UI elements 215 and may be selected when the mode of holding 305 is for a thumb-sweep, right-hand mode of holding. The arrangement 255B may define a first area 710A (also referred herein as a “natural area”) generally along the bottom left for the positions 705 of UI elements 215. The UI elements 215 to be placed in the first area 710A may have a higher number of interactions and may be easier for the hand 310 to interact with. The arrangement 255B may define a second area 710B (also referred herein as a “stretch area”) generally along the right side or the upper middle line of positions 705 for UI elements 215. The UI elements 215 to be placed in the second area 710B may have a lower number of interactions and may be moderately difficult for the hand 310 to interact with. The arrangement 255B may define a third area 710C (also referred herein as a “corner area”) generally along the top-right corner for the positions 705 of UI elements 215. The UI elements 215 to be placed in the third area 710C may have the lowest number of interactions and may be difficult for the hand 310 to interact with.

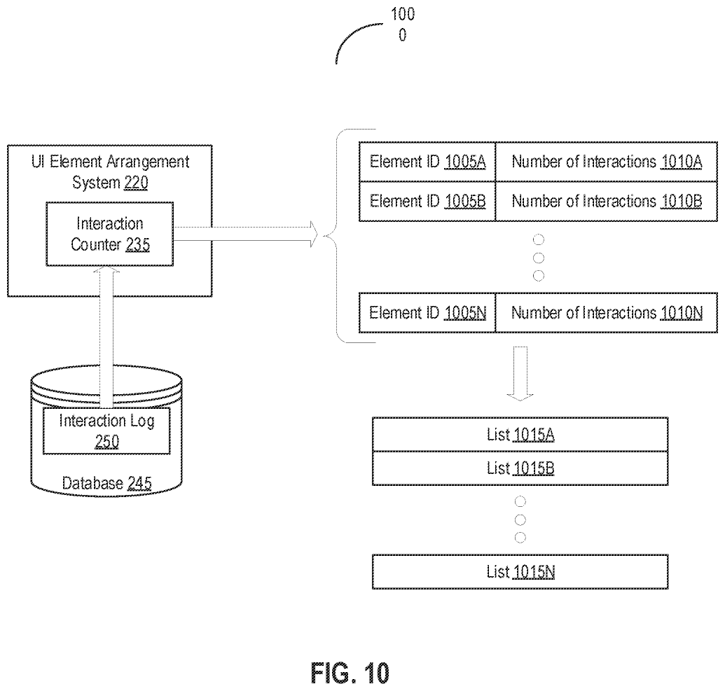

Referring now to FIG. 10, among others, depicted is a block diagram of a process 1000 for counting interactions in the system 200 for arranging user interface elements. The process 1000 may include or correspond to operations in the system 200 for determining the number of interactions on each UI element for presentation. Under the process 1000, the interaction monitor 235 executing on the UI elements arrangement system 220 may access the database 245 to fetch, retrieve, or otherwise identify the interaction log 250. The interaction log 250 may include or identify a set of element identifiers 1005A-N (hereinafter generally referred to as element identifiers 1005). Each element identifier 1005 may correspond to one UI element 215 presented on the display 210. For each element identifier 1005, the interaction log 250 may include or identify a number of interactions 1010A-N (hereinafter generally referred to as number of interactions 1010). The number of interactions 1010 may indicate or identify the number of user interactions (e.g., a screen touch, tap, or mouse click) on the respective UI element 205 corresponding to the element identifier 1005.

To maintain the interaction log 250, the interaction monitor 235 may listen, receive, or otherwise monitor for user interactions by the hand 310 of the user 260 with the UI elements 215 on the display 210 to keep track of the number of interactions 1010. When a user interaction is detected on one of the UI elements 215, the interaction monitor 235 may identify the UI element 215 on which the user interaction is detected. In the interaction log 250, the interaction monitor 235 may determine whether an element identifier 1005 exists for the identified UI element 215. If the element identifier 1005 does not exist, the interaction monitor 235 may create the element identifier 1005 for the UI element 215. If the element identifier 1005 exists or has been created, the interaction monitor 235 may update the number of interactions 1010 with the UI element 215. In some embodiments, the interaction monitor 235 may maintain a counter for each UI element 215 upon which the user interaction is detected. In updating, the interaction monitor 235 may increment the counter for the UI element 215.

In some embodiments, the interaction monitor 235 may include additional information for each element identifier 1005 for the corresponding UI element 215. Upon detection of the user interaction on one of the UI elements 215, the interaction monitor 235 may record or generate the information for the corresponding element identifier 1005. For each element identifier 1005, the information may identify or include, for example, an application name corresponding to the UI element 215 (e.g., when the UI element 215 is a mobile application icon), a type of the UI element 215 (e.g., command button, radio button, slider, textbox, icon for an application, or icon for folder), or a timestamp (e.g., an date, an hour, a minute, or seconds) corresponding to a time at which the user interaction is detected, among others. In some embodiments, the information may identify or include a set of pixel coordinates (e.g., x, y coordinates) or a grid location in the display 210 (e.g., or the application running on the device 205), among others, at which the user interaction was detected. The set of pixel coordinates or grid location may be used to construct the interaction heat map 600 as discussed above. The information for each element identifier 1005 may be kept as part of the interaction log 250.

The interaction monitor 235 may find or identify the set of UI elements 215 to be presented on the display 210 (or the application executing on the device 205). For each identified UI element 215, the interaction monitor 235 may retrieve, determine, or otherwise identify the number of interactions 1010 from the interaction log 250. In some embodiments, the interaction monitor 235 may identify a subset of user interactions from the interaction log 250 over a time window. The time window may be defined relative to the present time, and may range between a minute to a month. In some embodiments, the interaction monitor 235 may calculate or determine a predicted estimate for the number of interactions 1010 for each UI element 215 as a function of the subset of user interactions and a time for each user interaction. The estimate may identify the predicted number of interactions 1010 in a future relative to the present (e.g., over the next time window). The function may include, for example, a weighted moving average (WMA) or an exponential moving area (EMA), among others. In general, the function may weigh user interactions closer to the present more than user interaction further from the present.

With the determination, the interaction monitor 235 may categorize, associate, or otherwise assign the UI elements 215 into one of a set of lists 1015A-N (hereinafter generally referred to as lists 1015) based on the number of interactions 1010 (or the predicted estimates). The interaction monitor 235 may instantiate, create, or otherwise generate the set of lists 1015 corresponding to the set of areas 710 defined in the selected arrangement 255. Each list 1015 may be a data structure to maintain assignments of UI elements 215 thereto, such as a queue, a stack, a list, an array, a heap, a hash table, a tree, or a table, among others. The set of list 1015 may be the same number as the set of areas 710. Each list 1015 may have a size corresponding to the number of the subset of positions 705 for the arrangement 255. For example, if the first area 710A has M number of positions 705, the first list 1015A may have the size of M. If the second area 710B has N number of positions 705, the second list 1015B may have the size of N. If the third area 710C has O number of positions 705, the third list 1015C may have the size of O. In some embodiments, at least one of the lists 1015 may correspond to a global list with a size corresponding to the total number of UI elements 215 to be presented.

The interaction monitor 235 may rank, arrange, or otherwise sort the UI elements 215 by the number of interaction 1010. In some embodiments, the interaction monitor 235 may sort the UI elements 215 in the list 1015 corresponding to the global list. The sorting may be in accordance with a sorting algorithm, such as a quick sort, a merge sort, an insertion sort, a block sort, a tree sort, a bucket sort, or a cycle sort, among others. In accordance with the order for each UI element 215 from sorting, the interaction monitor 235 may assign the UI elements 215 to one of the set of lists 1015. Each list 1015 may be associated with an order of assignment based on the priority for the corresponding area 710 as defined by the arrangement 255. The interaction monitor 235 may identify the list 1015 associated with the area 1010 with the first in sequence or highest priority. Upon identification, the interaction monitor 235 may assign the UI elements 215 (of the corresponding element identifiers 1005) to one list 1015, until the number of assigned UI elements 215 matches the size for the list 1015. In some identification, the interaction monitor 235 may move, set, or transfer the assignment from the global list to the identified list 1015. When the number of assigned UI elements 215 matches the size, the interaction monitor 235 may identify the list 1015 with the next in priority as defined by the arrangement 255. The interaction monitor 235 may repeat the assignment of UI elements 255 accordingly.

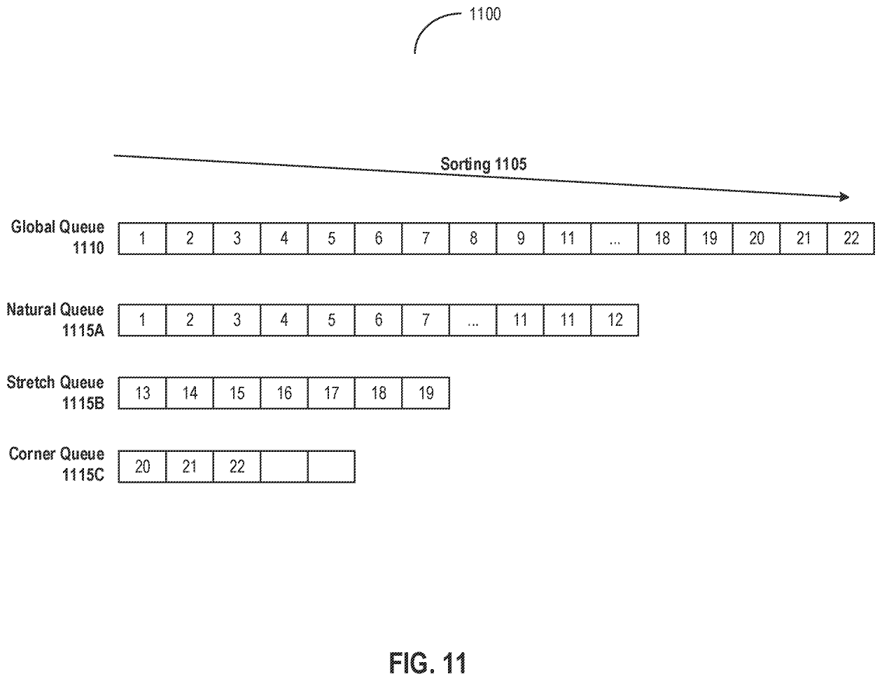

Referring now FIG. 11, among others, depicted is a block diagram of a process 1100 for sorting the user interface elements by count in the system 200 for arranging user interface elements. The process 1100 may correspond to or include operations in the system 200 for sorting and assigning the UI elements into the queues. Under the process 1100, the interaction monitor 235 may create a global queue 1110 corresponding to all the UI elements 215 to be presented. In addition, the interaction monitor 235 may create a natural queue 1115A, a stretch queue 1115B, and a corner queue 1115C in accordance with the definitions for the set of areas 710 as defined by the selected arrangement 255. The natural queue 1115A may correspond to the set of positions 705 of the natural area 710A. The stretch queue 1115B may correspond to the set of positions 705 of the stretch area 710B. The corner queue 1115C may correspond to the set of positions 705 of the corner area 710C. The queues 1110 and 1115A-C may be instances of the list described above.

With the creation, the interaction monitor 235 may perform sorting 1105 of the UI elements 215 by the number of interactions 1010 (of the predicted estimate) for each UI element 215. In performing the sorting 1105, the interaction monitor 235 may order the UI elements 215 in the global queue 1110 by the number of interactions 1010 (e.g., in descending from highest to lowest). From the global queue 1110, the interaction monitor 235 may assign the UI elements 215 into the one of the queues 1115A-C. The interaction monitor 235 may start assigning the UI elements 215 with the highest number of interactions 1010 first into the natural queue 1115A. Upon filling of the natural queue 1115A, the interaction monitor 235 may assign the remaining UI elements 215 with the next highest number of interactions 1010 then into the stretch queue 1115B. When the stretch queue 1115B is filled, the interaction monitor 235 may assign the remaining UI elements 215 with the next highest number of interactions 1010 last into the corner queue 1115C. Any UI elements 215 remaining in the global queue 1110 may remain unassigned from any of the other queues 1115A-C.

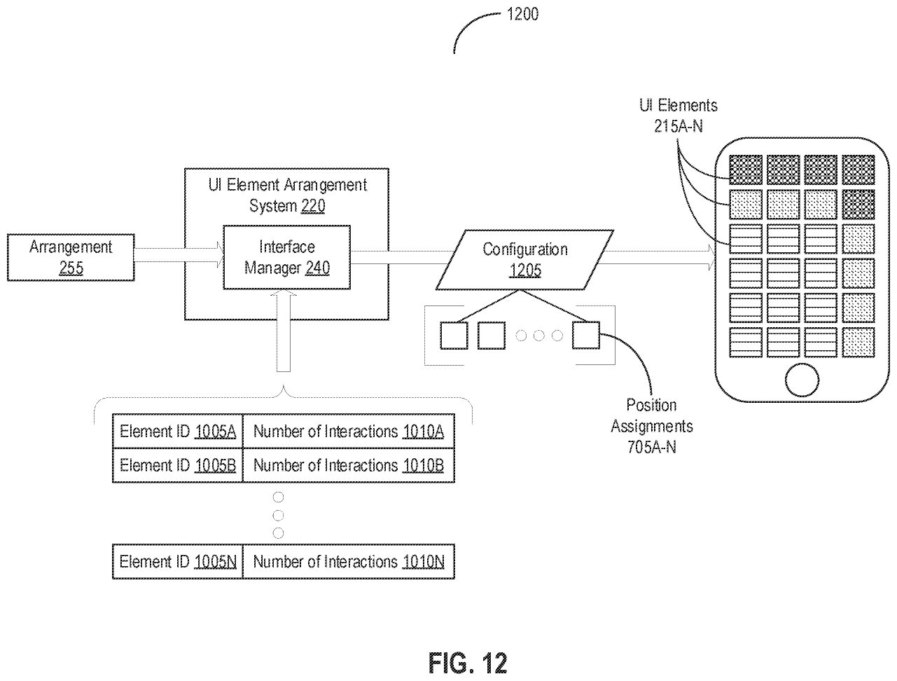

Referring now to FIG. 12, among others, depicted is a block diagram of a process 1200 for assigning positions for the user interface elements in the system 200 for arranging user interface elements. The process 1200 may correspond to or include operations in the system 200 to assign positions for user interface elements in accordance with the layout arrangement and the number of interactions. Under the process 1200, the interface manager 240 executing on the UI element arrangement system 220 may determine whether to arrange (or re-arrange) the UI elements 215 to present the display 210 (or the graphical user interface of the application on the device 205). In some embodiments, the interface manager 240 may determine whether to arrange the UI elements 215 by monitoring for a request for arrangement of the UI elements 215. The request for arrangement may be detected via a user interaction with a user interface element on the device 205. For example, the request for arrangement may be received via a menu item in a setting window for the display 210 on the operating system on the device 205 or the graphical user interface of the application running on the device 205. The request may allow the user 260 to manually trigger the arrangement of the UI elements 215. When no request is received, the interface manager 240 may determine to not arrange the UI elements 215. When the request for arrangement is received, the interface manager 240 may determine to arrange the UI elements 215. In some embodiments, the interface manager 240 may initiate the process 300 and onward, upon the determination to arrange the UI element 215.

In some embodiments, the interface manager 240 may determine whether to arrange the UI elements 215 by monitoring switches of the mode of holding 315. The interface manager 240 may invoke the grasp detector 225 (e.g., on a time interval, a schedule, or at random) to detect the mode of holding 315 has changed based on new input, such as additional records in the interaction log 205 or the user data 315, among others. When the currently detected mode of holding 305 differs from the previously detected mode of holding 305, the interface manager 240 may identify, determine, or otherwise detect the switch in mode of holding 305 of the device 205. Otherwise, when the currently detected mode of holding 305 is the same as the previously detected mode of holding 305, the interface manager 240 may determine no switch in the mode of holding 305. The interface manager 240 may determine to not arrange the UI elements 215, and may continue monitoring. When the switch in the mode of holding 305 is detected, the interface manager 240 may determine to arrange the UI elements 215. Upon detection of the switch in the mode of holding 305, the interface manager 240 may determine to arrange the UI elements 215, and may initiate the process 300 and onward.

The interface manager 240 may identify or select a position 705 to assign from the set of positions 705 defined in the arrangement 255, for each UI element 215. The selection of the positions 705 may be based on the number of interactions 1010 (or the predicted estimate) for each UI element 215 in accordance with the identified arrangement 255. In some embodiments, the interface manager 240 may initiate select the position 705 for each UI element 215, in response to the determination to arrange the UI elements 215 on the display 210. As discussed above, the arrangement 255 may define the sequence (or priority) of assignment of the UI elements 215 into the set of positions 705. Based on the sequence defined by the arrangement 255 and the number of interactions 1010 for each UI element 215, the interface manager 240 may assign the position 705 to the UI element 215. From the sorting, the interface manager 240 may identify the UI element 215 with the highest number of interactions 1010, and select the position 705 that is first in sequence as defined by the arrangement 255. The interface manager 240 may then identify the UI element 215 with the next highest number of interactions, and select the position 705 that is next in the sequence. The interface manager 240 may repeat the identification of the UI element 215 and selection of the position 705 until the end of the set of UI elements 215.

In some embodiments, the interface manager 240 may select the position 705 for each UI element 215 in accordance the set of lists 1015. As discussed above, each list 1015 may be associated with a corresponding area 710, and each area 710 may be associated with a priority of insertion of a corresponding subset of UI elements 215. Furthermore, each list 1015 may be assigned with the UI elements 215 in accordance with the sorting. From each list 1015, the interface manager 240 may fetch, retrieve, or otherwise identify the subset of UI elements 215 assigned to the list 1015. The interface manager 240 may identify the area 710 corresponding to the list 1015 for the subset of UI elements 215. In some embodiments, the interface manager 240 may assign the subset of UI elements 215 to the area 710 associated with the list 1015. For each UI element 215 of the subset, the interface manager 240 may select one of the positions 705 in the area 710 to assign to the UI element 215. The assignment of the positions 705 may be based on the sequence and the number of interactions 1010 for each UI element 215 in a similar manner as discussed above. The interface manager 240 may repeat the identification of the subset of UI elements 215 for each list 1015 and selection of the positions 705 for assignment, until the end of the set of lists 1015.

With the assignment of positions 705, the interface manager 240 may apply or provide at least one configuration 1205. In some embodiments, the interface manager 240 may create, produce, or otherwise generate the configuration 1205 using the assignment of positions 705 and the arrangement 255. The configuration 1205 may specify, identify, or otherwise define the UI elements 215 on the display 210 (or the graphical user interface of the application) in accordance with the assignment of positions 705. For each UI element 215, the configuration 1205 may identify the pixel coordinates (e.g., x, y coordinates) or the grid location corresponding to the position 705 assigned to the UI element 215. In applying, the interface manager 240 may change, modify, or otherwise set the presented location of each UI element 215 to the position 705 as assigned to the UI element 215. In some embodiments, the interface manager 240 may set the position 705 of each UI element 215 (e.g., on a page layout) of the operating system on the device 205 rendered on the display 210. In some embodiments, the interface manager 240 may set the position 705 of each UI element 205 (e.g., within a window) of the application running on the device 205 rendered on the display 210.

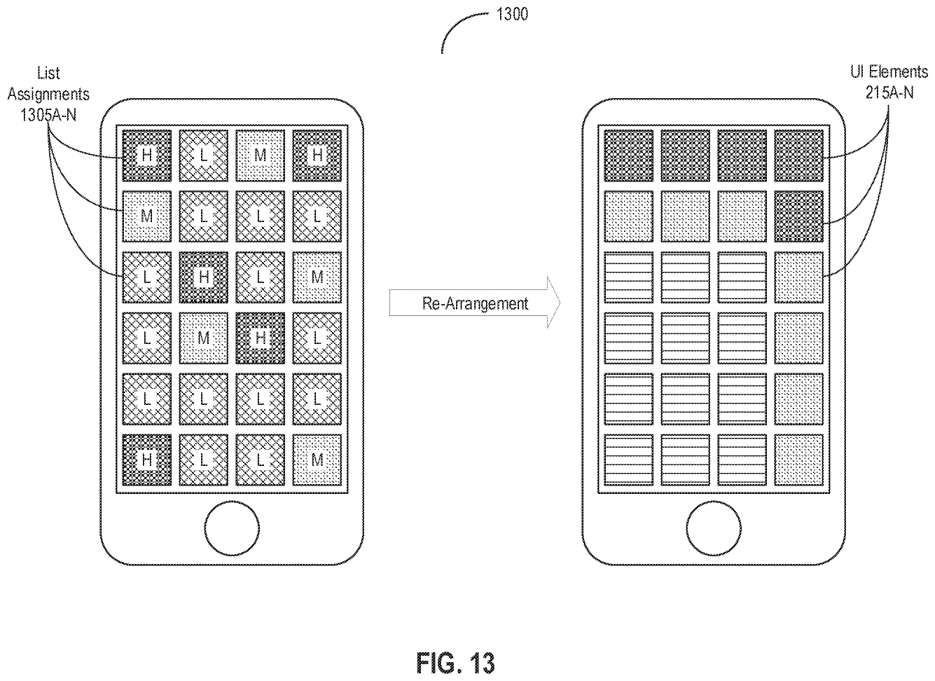

Referring now to FIG. 13, among others, depicted is a block diagram of an example of a re-arrangement 1300 of user interface elements in the system for arranging user interface elements. As depicted on the left, the interface manager 240 may assign each of the UI elements 215 to one of the lists 1010 and by extension, one of the areas 710. The interface manager 240 may assign a subset of the UI elements 215 (marked as “L”) into the first list 1010A and the first area 710A corresponding to a low level of difficulty of reach by the hand 310 for the detected mode of holding 305. The interface manager 240 may assign another subset of the UI elements 215 (marked as “M”) into the first list 1010B and the first area 710B corresponding to a medium level of difficulty of reach by the hand 310 for the detected mode of holding 305. The interface manager 240 may assign another subset of the UI elements 215 (marked as “H”) into the third list 1010C and the third area 710C corresponding to a highest level of difficulty of reach by the hand 310 for the detected mode of holding 305.

Moving on the depiction on the right, the interface manager 240 may set the UI elements 215 to the positions 705 in accordance with the assignment to the areas 710A-C. The subset of UI elements (marked as “L”) may be arranged to be located in the bottom left region of the display 210 corresponding to the first area 710A. The subset of UI elements (marked as “M”) may be arranged to be located in the right edge region and top-middle left region of the display 210 corresponding to the second area 710B. The subset of UI elements (marked as “H”) may be arranged to be located in the upper right corner region of the display 210 corresponding to the third area 710C.

In this manner, the UI elements 215 with the highest numbers of interactions 1010 may be arranged to be positioned within relatively convenient reach to the hand 310 of the user 260 for the given mode of holding 305. Conversely, the UI elements 215 with the lowest numbers of interactions 1010 may be arranged to be located and relatively difficult to reach from the hand 310 of the user 260, given the detected mode of holding 305. By arranging in accordance with the number of interactions 1010 and the arrangement 225 for the detected mode of holding 305, the UI element arrangement system 220 may improve the quality of human computer interactions (HCI) between the device 205 and the user 260. Furthermore, the UI element arrangement system 220 may further increase the convenience and utility of the overall device 205, with the automated rearrangement of UI elements 215. The UI element arrangement system 220 may also decrease the consumption in computing resources (e.g., processing and memory) incurred from the user 260 accidentally interacting with UI elements 215 that are easier to reach but not frequently used by the user 260.

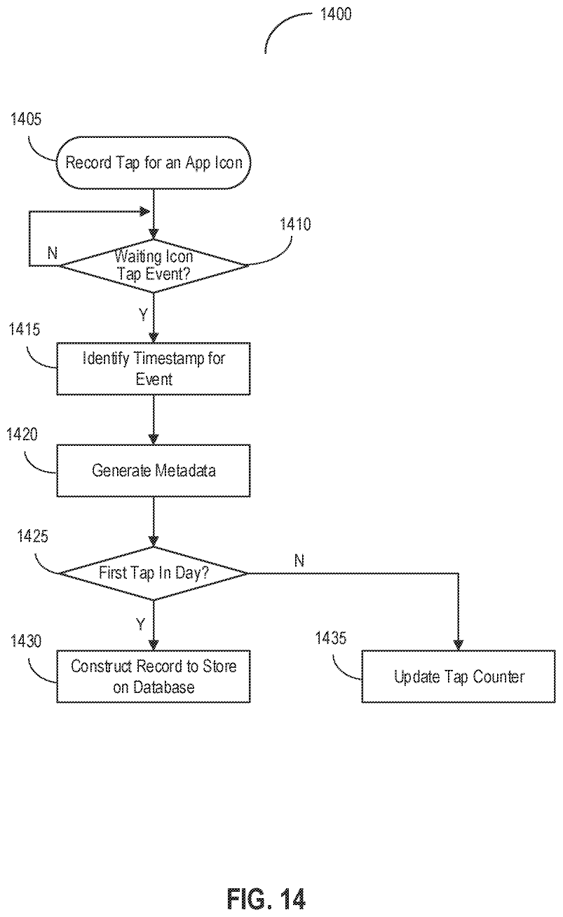

Referring now to FIG. 14, among others, depicted is a flow diagram of a method 1400 of counting user interactions on user interface elements. The operations and functionalities of the method 1400 may be performed by the components described herein in FIGS. 1-12, such as the device 205 and the UI element arrangement system 220. Under method 1400, the device may record a tap for an application icon (1405). The device may wait for an icon tap event (1410). When a tap is detected, the device may identify a timestamp for the event (1415). The device may generate metadata for the event (1420). The device may determine whether the tap is first in the day (1425). If the tap is the first for the data, the device may construct a record to store on the database (1430). Otherwise, if the tap is not the first for the data, the device may update tap counter (1435).

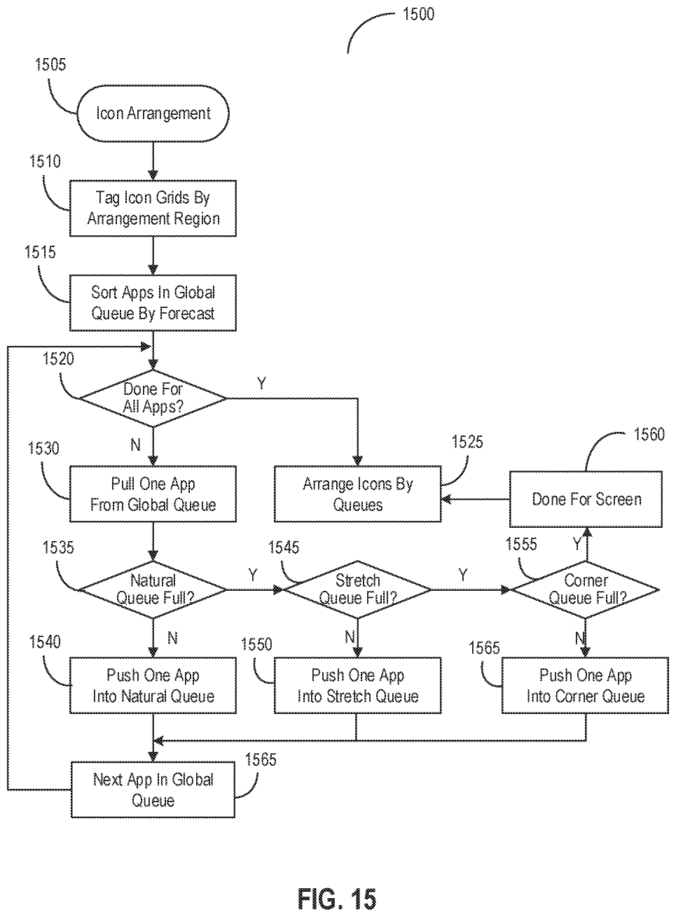

Referring now to FIG. 15, among others, depicted is a flow diagram of a method 1500 of sorting user interface elements by count and assigning user interface elements into queues. The operations and functionalities of the method 1500 may be performed by the components described herein in FIGS. 1-12, such as the device 205 and the UI element arrangement system 220. Under method 1500, the device may initiate an icon arrangement (1505). The device may tag icon grids by arrangement region (1510). The device may sort applications in global queue by forecasted number of interactions (1515). The device may determine whether the assignment is complete across all application icons (1520). If the assignment is complete, the device may arrange the application icons by queues (1525).

Continuing on, if the assignment is not complete, the device may pull one application icon from the global queue (1530). The device may determine whether the natural queue is full (1535). If the natural queue is not full, the device may push the application icon into the natural queue (1540). If the natural queue is full, the device may determine whether the stretch queue is full (1545). If the stretch queue is not full, the device may push the application icon into the stretch queue (1550). If the stretch queue is full, the device may determine whether the corner queue is full (1555). If the corner queue is full, the device may determine that the assignment of icons onto the screen is complete (1560) and arrange the application icons by queues (1525). Otherwise, if the corner queue is not full, the device may push the application icon into the corner queue (1565). The device may identify the next application icon in the global queue (1565), and repeat the process from (1520).

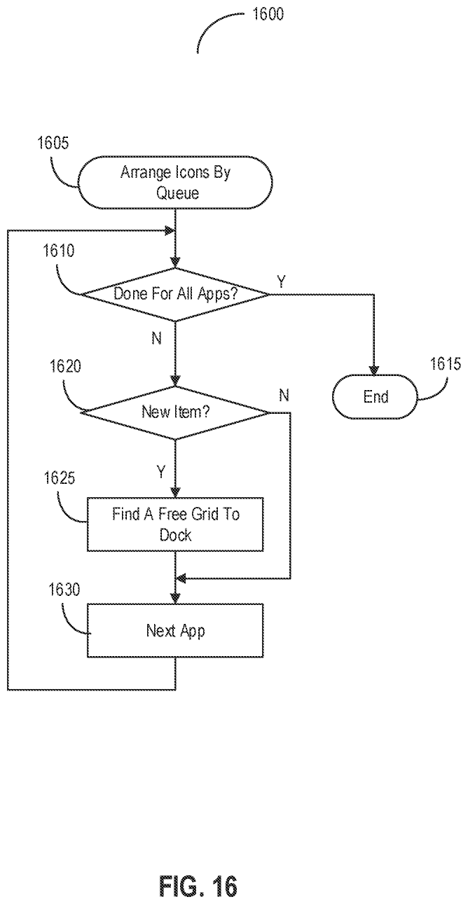

Referring now to FIG. 16, among others, depicted is a flow diagram of a method 1600 of assigning user interface elements into grid positions. The operations and functionalities of the method 1600 may be performed by the components described herein in FIGS. 1-12, such as the device 205 and the UI element arrangement system 220. Under method 1600, the device may initiate arrangement of application icons by a queue (e.g., the natural queue) (1605). The device may determine whether the assignment is complete across all applications (1610). If the assignment is determined to be complete, the device may terminate the process (1615). Otherwise, if the assignment is determined to be not complete, the device may determine whether the application icon is new (1620). When new, the device may find a free grid position to dock or insert the application icon (1625). The device may identify the next application icon (1630).

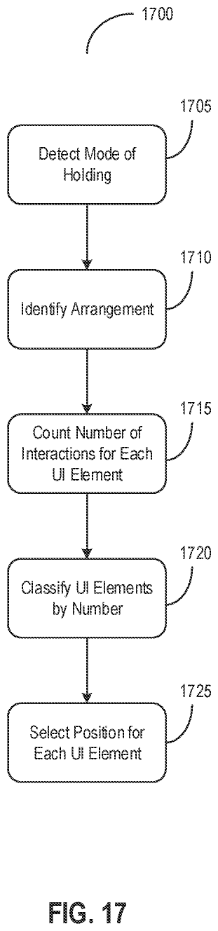

FIG. 17 is a flow diagram of a method 1700 of arranging user interface elements. The operations and functionalities of the method 1700 may be performed by the components described herein in FIGS. 1-12, such as the device 205 and the UI element arrangement system 220. Under method 1700, the device (e.g., the device 205) may detect a mode of holding (e.g., the mode of holding 305) the device by a hand (e.g., the hand 310) of a user (e.g., the user 260) (1705). The device may identify an arrangement (e.g., the arrangement 255) defining a set of positions (e.g., the positions 705) to present a corresponding set of UI elements (e.g., the UI elements 2150) (1710). The device may count a number of interactions (e.g., the number of interactions 1010) for each UI element (1715). The device may classify UI elements by the number of interactions (1720). The device may select a position for each UI element in accordance with the arrangement based on the number of interactions (1725).

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method of selecting a position for an user interface element, comprising:
detecting, by a device, a mode of holding the device by a hand of a user using an input of the user;
identifying, by the device, an arrangement defining a plurality of positions to present a corresponding plurality of user interface elements on a display based at least on the mode of holding;
determining, by the device, a number of interactions by the hand of the user with a user interface element; and
selecting, by the device, from the plurality of positions, a position to present the user interface element on the display based at least on the number of interactions in accordance with the arrangement.

2. The method of claim 1, wherein detecting the mode of holding further comprises detecting the mode of holding based at least on a position of an eye of the user relative to the display determined using the input including an image of the user.

3. The method of claim 1, wherein detecting the mode of holding further comprises detecting the mode of holding based at least on the input identifying a plurality of coordinates for a plurality of interactions on the display.

4. The method of claim 1, wherein detecting the mode of holding further comprises detecting the mode of holding based at least on the input including a fingerprint of the user acquired via the device.

5. The method of claim 1, wherein identifying the arrangement further comprises selecting the arrangement from a plurality of arrangements for a corresponding plurality of modes of holding, each of the plurality of arrangements defining a sequence for the plurality of positions.

6. The method of claim 1, wherein determining the number of interactions further comprises determining an estimate for the number of interactions as a function of a plurality of interactions with the user interface element over a time window.

7. The method of claim 1, further comprising:
sorting, by the device, the plurality of user interface elements by the number of interactions by the hand of the user with each of the plurality of user interface elements; and
identifying, by the device, from a plurality of areas defined by the arrangement, an area of the display for the user interface element in accordance with sorting the plurality of the user interface elements,
wherein selecting the position further comprises selecting the position from a subset of positions defined for the area by the arrangement.

8. The method of claim 1, further comprising:
detecting, by the device, a switch from the mode of holding the device to a second mode of holding the device using a second input of the user; and
determining, by the device, to arrange the plurality of user interface elements on the display responsive to detecting the switch to the second mode of holding.

9. The method of claim 1, further comprising:
receiving, by the device, from the user, a request to arrange the plurality of user interface elements on the display; and
determining, by the device, to arrange the plurality of user interface elements on the display responsive to receiving the request.

10. The method of claim 1, further comprising maintaining, by the device, a counter to track the number of interactions by the user with the user interface element on the device.

11. A system for selecting a position for an user interface element, comprising:
a device having one or more processors coupled with memory, configured to:
detect a mode of holding the device by a hand of a user using an input of the user;
identify an arrangement defining a plurality of positions to present a corresponding plurality of user interface elements on a display based at least on the mode of holding;
determine a number of interactions by the hand of the user with a user interface element; and
select, from the plurality of positions, a position to present the user interface element on the display based at least on the number of interactions in accordance with the arrangement.

12. The system of claim 11, wherein the device is further configured to detect the mode of holding based at least on a position of an eye of the user relative to the display determined using the input including an image of the user.

13. The system of claim 11, wherein the device is further configured to detect the mode of holding based at least on the input identifying a plurality of coordinates for a plurality of interactions on the display.

14. The system of claim 11, wherein the device is further configured to select the arrangement from a plurality of arrangements for a corresponding plurality of modes of holding, each of the plurality of arrangements defining a sequence for the plurality of positions.

15. The system of claim 11, wherein the device is further configured to determine an estimate for the number of interactions as a function of a plurality of interactions with the user interface element over a time window.

16. The system of claim 11, wherein the device is further configured to
sorting, by the device, the plurality of user interface elements by the number of interactions by the hand of the user with each of the plurality of user interface elements;
identifying, by the device, from a plurality of areas defined by the arrangement, an area of the display for the user interface element in accordance with sorting the plurality of the user interface elements; and
select the position from a subset of positions defined for the area by the arrangement.

17. The system of claim 11, wherein the device is further configured to:
detect a switch from the mode of holding the device to a second mode of holding the device using a second input of the user; and
determine to arrange the plurality of user interface elements on the display responsive to detecting the switch to the second mode of holding.

18. A non-transitory computer readable medium storing program instructions for causing one or more processors to:
detect a mode of holding a device by a hand of a user using an input of the user;
identify an arrangement defining a plurality of positions to present a corresponding plurality of user interface elements on a display based at least on the mode of holding;
determine a number of interactions by the hand of the user with a user interface element; and
select, from the plurality of positions, a position to present the user interface element on the display based at least on the number of interactions in accordance with the arrangement.

19. The non-transitory computer readable medium of claim 18, wherein the instructions further cause the one or more processors to detect the mode of holding based at least on a position of an eye of the user relative to the display determined using the input including an image of the user.

20. The non-transitory computer readable medium of claim 18, wherein the instructions further cause the one or more processors to:
sorting, by the device, the plurality of user interface elements by the number of interactions by the hand of the user with each of the plurality of user interface elements;
identifying, by the device, from a plurality of areas defined by the arrangement, an area of the display for the user interface element in accordance with sorting the plurality of the user interface elements; and
select the position from a subset of positions defined for the area by the arrangement.
